(19) United States
(12) Patent Application Publication
(10) Pub. No.: US 2014/0067388 A1
(43) Pub. Date: Mar. 6, 2014

(54) ROBUST VOICE ACTIVITY DETECTION IN ADVERSE ENVIRONMENTS

(71) Applicant: Samsung Electronics Co. Ltd., Suwon-si (KR)

(72) Inventors: M. Sabarimalai Manikandan, Chittoor (IN); Saurabh TYAGI, Ghaziabad (IN)

(73) Assignee: Samsung Electronics Co., Ltd., Suwon-si (KR)

(21) Appl. No.: 14/017,983

(22) Filed: Sep. 4, 2013

(30) Foreign Application Priority Data
Sep. 5, 2012 (IN) 2761/DEL/2012

(51) Int. Cl. G10L 15/20

(52) U.S. Cl. CPC G10L 15/20
USPC 704/233

(57) ABSTRACT

A method and a system for robust voice activity detection under adverse environments are provided. The apparatus includes a controller for controlling a signal receiving module, a signal blocking module, a silent/non-silent classification module for discriminating silent blocks by comparing a temporal feature to a threshold, a total variation filtering module for enhancing voiced portions and reducing an effect of background noises, a frame division module for dividing a filtered signal into small frames, a residual processing module for estimating a noise floor, a silent/non-silent frame classification module, a voice/non-voice signal frame classification module based on autocorrelation features of a total variation filtered signal, a binary-flag merging and deletion module, a voice endpoint detection and correction module, and a voice endpoint storing/sending module. A decision-tree is arranged based on time and memory complexity of feature extraction methods. The system is able to determine voice region endpoints under different adverse environments.

### CROSS-REFERENCE TO RELATED APPLICATION(S)

This application claims the benefit under 35 U.S.C. §119(a) of an Indian patent application filed on Sep. 5, 2012 in the Intellectual Property of India and assigned Serial No. 2761/DEL/2012, the entire disclosure of which is hereby incorporated by reference.

### TECHNICAL FIELD

The present disclosure relates to the field of speech and audio processing. More particularly, the present disclosure relates to voice activity detection in a voice processing apparatus under adverse environmental.

### BACKGROUND

Recent growth in communication technologies and concurrent development of powerful electronic devices has enabled the development of various multimedia related techniques. However, the use of many voice-enabled devices, systems, and communication technologies is limited due to issues related to battery life (or power consumption) of the device, accuracy, transmission, and storage cost. In audio processing and communication systems, the overall performance in terms of accuracy, computational complexity, memory consumption, and other factors greatly depends on the ability to discriminate voice based speech signal from a non-voice/noise signal present in an input audio signal under an adverse environment, where various kinds of noises exist.

Existing systems and methods have attempted to develop voice/speech activity detection, voice and non-voice detection, temporal and spectral features based systems, source-filter based systems, time-frequency domain based systems, audio-visual based systems, statistical based systems, entropy based systems, short-time spectral analysis systems, and speech endpoint/boundary detection for discriminating a voice signal portion and a non-voice signal portion by using feature information extracted from the input signal. However, it is difficult to detect and extract a voice signal portion, since the voice signal is usually corrupted by a wide range of background sounds and noises.

The existing systems and methods for voice/speech detection have many shortcomings such as: (i) the systems and methods may be diminished under highly non-stationary and low Signal-to-Noise Ratio (SNR) environments; (ii) the systems and methods may be less robust under various types of background sound sources including applause, laughter, crowd noises, cheering, whistling, explosive sounds, babble, train noise, car noise, and so on; (iii) the systems and methods include less discriminative power in characterizing the signal frames having periodic structured noise components; and (iv) fixing a peak amplitude threshold for computing the periodicity from the autocorrelation lag index is very difficult under different noises and noise levels.

Due to the above mentioned reasons, the existing systems and methods fail to provide better detection when the level of background noise increases and a signal is corrupted by the time-varying noise levels. Thus, the use of appropriate noise robust features to characterize speech and non-speech signals is critical for all detection problems. Hence, there is a need for a system which achieves a better detection performance at a low computational cost.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and system to achieve robust voice activity detection under adverse environmental conditions.

Another aspect of the disclosure is to provide a method to determine endpoints of voice regions.

Another aspect of the disclosure is to provide a method to perform noise reduction and to improve the robustness of voice activity detection against different kinds of realistic noises at varying noise levels.

In accordance with an aspect of the present disclosure, a method for Voice Activity Detection (VAD) in adverse environmental conditions is provided. The method includes receiving an input signal from a source, classifying the input signal into a silent or non-silent signal block by comparing temporal feature information, sending the silent or non-silent signal block to a Voice Endpoint Storing (VES) module or total variation filtering module by comparing the temporal feature information to thresholds, determining endpoint information of a voice signal or non-voice signal, employing total variation filtering for enhancing speech features and suppressing noise levels in non-speech portions, determining a noise floor in the total variation filtered signal domain, determining feature information in autocorrelation of the total variation filtered signal sequence, determining Binary-flag Storing, Merging and Deletion (BSMD) based on the duration threshold on the determined feature information by a BSMD module, determining a voice endpoint correction based on short-term temporal feature information after the determined BSMD, and outputting the input signal with the voice endpoint information.

Accordingly the disclosure provides a system for VAD in adverse environmental conditions. The system is configured for receiving an input signal from a source. The system is also configured for classifying the input signal into a silent or non-silent signal block by comparing temporal feature information. The system is also configured for sending the silent or non-silent signal block to a VES module or a total variation filtering module by comparing the temporal feature information to the thresholds. The system is also configured for determining endpoint information of a voice signal or a non-voice signal. The system is also configured for employing total variation filtering for enhancing speech features and suppressing noise levels in non-speech portions. Further, the system is configured for determining a noise floor in the total variation filtered signal domain, determining feature information in autocorrelation of the total variation filtered signal sequence. Furthermore, the system is configured for determining BSMD based on the duration threshold on the determined feature information. Furthermore, the system is configured for determining voice endpoint correction based on the short-term temporal feature information after the determined BSMD and outputting the input signal with the voice endpoint information.

In accordance with another aspect of the present disclosure, an apparatus for voice activity detection in adverse environmental conditions is provided. The apparatus includes an integrated circuit including a processor, and a memory having a computer program code within the integrated circuit. The memory and the computer program code are configured to, with the processor, cause the apparatus to receive an input signal from a source. The processor causes the apparatus to classify the input signal into a silent or non-silent signal block by comparing temporal feature information. The processor causes the apparatus to send the silent or non-silent signal block to a VES module or a total variation filtering module by comparing the temporal feature information to thresholds. Further, the processor causes the apparatus to determine endpoint information of a voice signal or a non-voice signal by the VES module or the total variation filtering module. Furthermore, the processor causes the apparatus to employ total variation filtering by the total variation filtering module for enhancing speech features and suppressing noise levels in non-speech portions. Furthermore, the processor causes the apparatus to determine a noise floor in the total variation filtered signal domain. Furthermore, the processor causes the apparatus to determine feature information in autocorrelation of the total variation filtered signal sequence. Furthermore, the processor causes the apparatus to determine BSMD based on the duration threshold on the determined feature information by a BSMD module. Furthermore, the processor causes the apparatus to determine voice endpoint correction based on short-term temporal feature information after the determined BSMD, and output the input signal with the voice endpoint information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a schematic block diagram of an arrangement of speech and audio processing applications with a voice activity detector apparatus in accordance with various embodiments of the present disclosure;

FIG. 2 illustrates a block diagram of a voice activity detector module in accordance with various embodiments of the present disclosure;

FIG. 3 illustrates a flow diagram which describes a process of voice activity detection in accordance with various embodiments of the present disclosure;

FIG. 4 illustrates a flow diagram explaining a method for determining a silent signal block and a non-silent block in accordance with various embodiments of the present disclosure;

FIGS. 5A to 5E illustrate graphs indicating effectiveness of total variation filtering under a realistic noise environment in accordance with various embodiments of the present disclosure;

FIGS. 6A to 6D illustrate graphs indicating effectiveness of total variation filtering for a speech signal corrupted by babble noise with varying noise levels in accordance with various embodiments of the present disclosure;

FIGS. 7A to 7D illustrate graphs indicating effectiveness of total variation filtering for a speech signal corrupted by airport noise in accordance with various embodiments of the present disclosure;

FIGS. 8A to 8D illustrate graphs indicating noise-reduction capability of total variation filtering for a speech signal corrupted by time-varying levels of additive white Gaussian noise in accordance with various embodiments of the present disclosure;

FIG. 9 illustrates a flow diagram explaining a process for determining Silent/Non-silent Frame Classification (SNFC) in accordance with various embodiments of the present disclosure;

FIGS. 10A to 10C illustrate graphs indicating experimental results of SNFC in accordance with various embodiments of the present disclosure;

FIGS. 11A to 11C illustrate graphs indicating experimental results of SNFC in accordance with various embodiments of the present disclosure;

FIG. 12 illustrates a flow diagram explaining Voice/Non-voice signal Frame Classification (VNFC) in accordance with various embodiments of the present disclosure;

FIGS. 13A to 13F illustrate graphs indicating patterns of features extracted from autocorrelation of a total variation filtered signal in accordance with various embodiments of the present disclosure;

FIG. 14 illustrates a flow diagram explaining a process of Binary-flag Storing, Merging, and Deletion (BSMD) in accordance with various embodiments of the present disclosure;

FIGS. 15A to 15F illustrate graphs indicating outputs of speech corrupted by train noise in accordance with various embodiments of the present disclosure;

FIGS. 16A to 16F illustrate graphs indicating outputs for a clean speech signal in accordance with various embodiments of the present disclosure;

FIG. 17 illustrates a flow diagram explaining a process of Voice Endpoint Determination and Correction (VEDC) in accordance with various embodiments of the present disclosure;

FIGS. 18A to 18E illustrate graphs indicating outputs of a VNFC module, a BSMD module and a VEDC module in accordance with various embodiments of the present disclosure;

FIGS. 19A to 19E illustrate graphs indicating outputs of a VNFC module, a BSMD module and a VEDC module in accordance with various embodiments of the present disclosure;

FIGS. 20A to 20E illustrate graphs indicating outputs of a VNFC module, a BSMD module and a VEDC module in accordance with various embodiments of the present disclosure; and

FIG. 21 illustrates a computing environment implementing the application in accordance with various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The various embodiments herein achieve a method and system of a voice activity detection which can be used in a wide range of audio and speech processing applications. The proposed method accurately detects voice signal regions and determines endpoints of voice signal regions in audio signals under diverse kinds of background sounds and noises with varying noise levels.

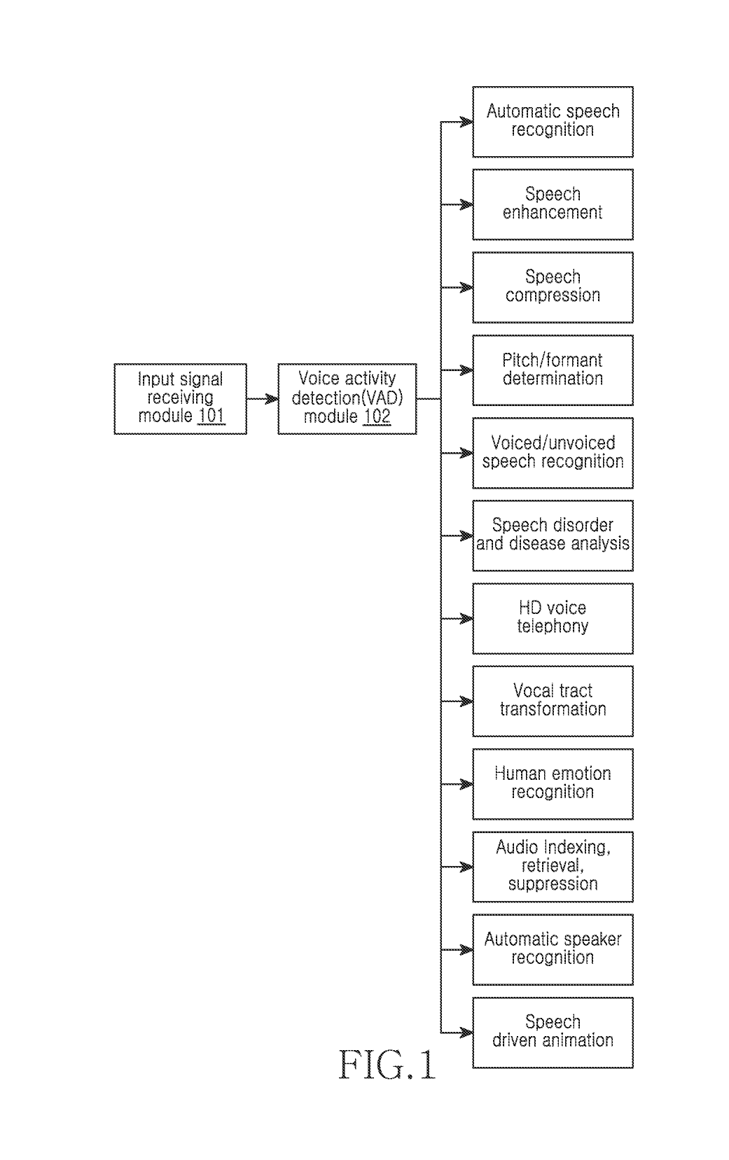

Referring now to the drawings, and more particularly to FIGS. 1 through 21, where similar reference characters denote corresponding features consistently throughout the figures, there are shown embodiments of the present disclosure.

FIG. 1 illustrates a schematic block diagram of an arrangement of speech and audio processing applications with a voice activity detector apparatus in accordance with various embodiments of the present disclosure.

Referring to FIG. 1, an Input Signal Receiving (ISR) module 101 provides a data acquisition interface to receive an input signal from different sources. In an embodiment, the sources can be portable devices, microphones, storage devices, communication channels, and the like. The ISR module 101 indicates the received data (or signal) format such as sampling frequency (e.g., number of samples per second), sample resolution (e.g., number of bits per sample), coding standards, and the like. Further, the ISR module 101 includes a method for converting the received data into a waveform, and provides a method to resample the received signal at a sampling rate or change the sampling-rate conversion if required. The ISR module 101 handles the standard coding and sampling rates utilized in various audio signal processing systems. The outputs of one or more microphones are coupled with Analog to Digital Converters (ADCs) which provide a digital form of an analog signal for ADC specifications. The ISR module 101 further supports construction of the signal from the measurements received from a compressive sensing system by using the sparse coding with a convex optimization technique. A Voice Activity Detection (VAD) module 102 can be used for several applications which may not be limited to automatic speech recognition, speech enhancement (e.g., noise modeling), speech compression, pitch/formant determination, voiced/unvoiced speech recognition, speech disorder and disease analysis, High Definition (HD) voice telephony, vocal tract information, human emotion recognition, audio indexing retrieval, suppression, automatic speaker recognition, speech driven animation, and the like.

In an embodiment, the VAD module 102 can be an integrated circuit, System-on-a-Chip (SoC or SOC), a communication device (e.g., mobile phone, Personal Digital Assistant (PDA), tablet), and the like.

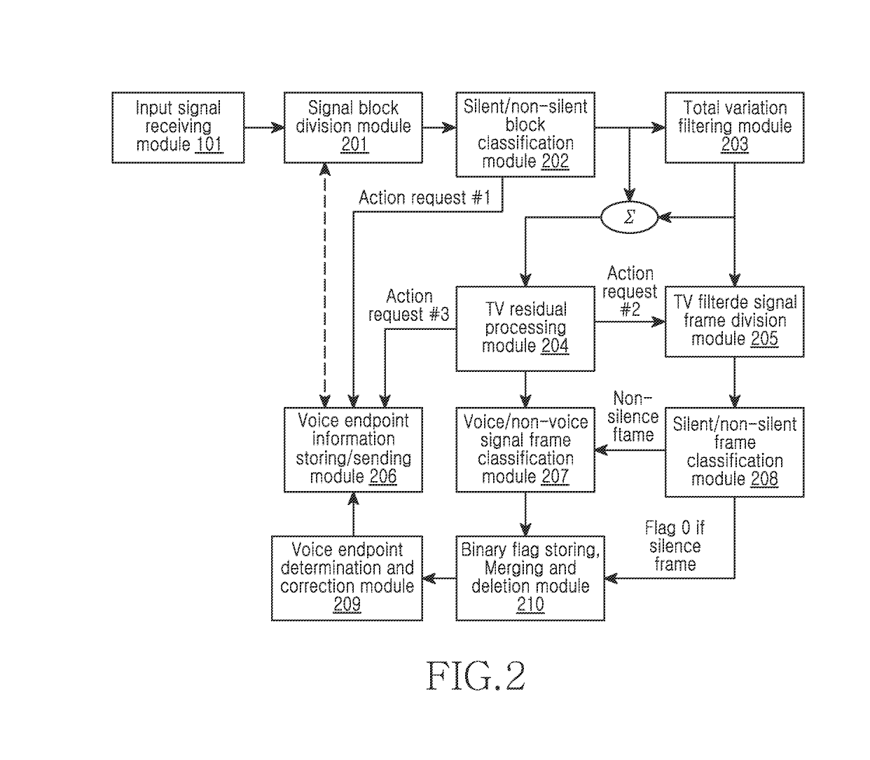

FIG. 2 illustrates a block diagram of a VAD module in accordance with various embodiments of the present disclosure.

Referring to FIG. 2, the VAD module is used for determining an endpoint of a voice signal portion of an audio signal. The VAD module comprises an ISR module 101, a Signal Block Division (SBD) module 201, a Silent/Non-silent Block Classification (SNBC) module 202, a Total Variation Filtering (TVF) module 203, a Total Variation Residual Processing (TVRP) module 204, a total variation filtered Signal Frame Division (SFD) module 205, a Voice Endpoint Storing/sending (VES) module 206, a Voice/Non-voice signal Frame Classification (VNFC) module 207, a Silent/Non-silent Frame Classification (SNFC) module 208, a Voice Endpoint Determination and Correction (VEDC) module 209, and a Binary-flag Storing, Merging and Deletion (BSMD) module 210.

In an embodiment, the SBD module 201 includes a memory buffer, a plurality of programs, and a history of memory allocations. Further, the SBD module 201 sets a block length based on a buffer memory size of the processing device, and divides the input discrete-time signal received from the data acquisition module into equal-sized blocks of N×1 samples. The selection of an appropriate block length depends on the type of applications of interest, as well as on the memory size allocated for a scheduled task and other internal resources, such as processor power consumption, processor speed, memory, or I/O (Input/Output) of audio communication and processing devices.

Further, the SBD module 201 waits for a specific period of time for the audio data to be acquired sufficiently, and releases collected data for further processing as the memory buffer gets full. The SBD module 201 holds data for a short period of time until finishing the VAD process. The internal memories of the SBD module 201 will be refreshed periodically. The next block processing continues based on action variable information. The SBD module 201 maintains history information including a start and endpoint position of a block, a memory size, and action variable state information.

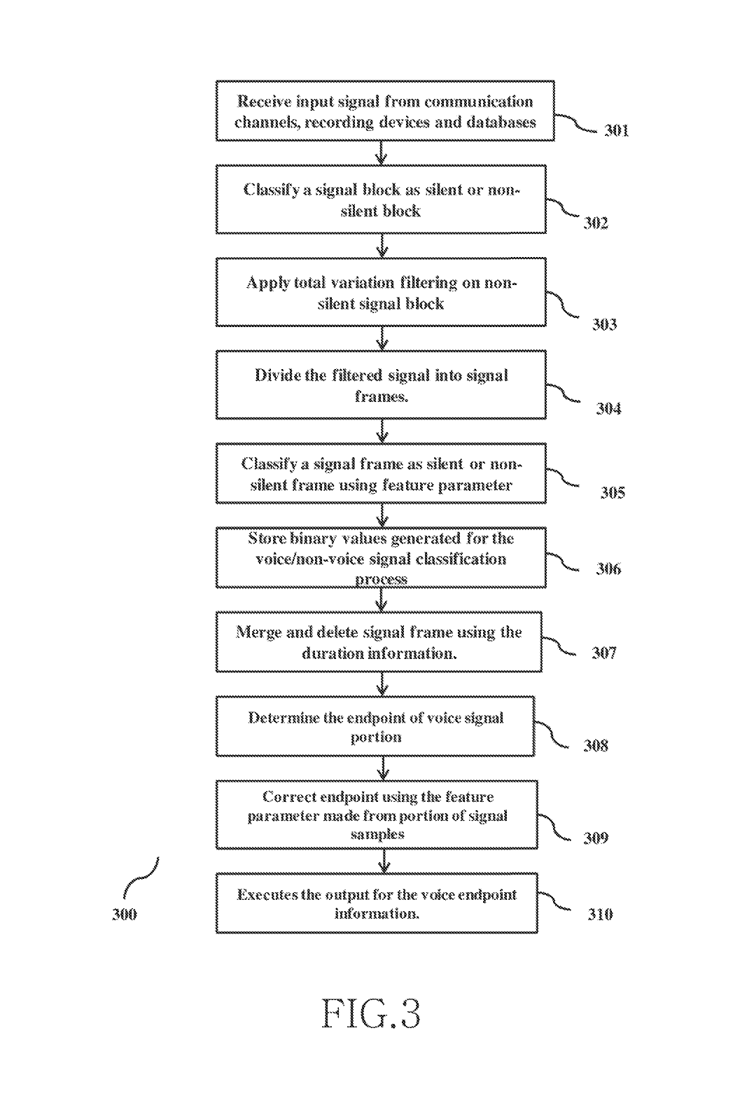

FIG. 3 illustrates a flow diagram which describes a process of voice activity detection in accordance with various embodiments of the present disclosure.

Referring to FIG. 3, flow diagram 300 includes operation 301 at which an input signal is initially received from one or more communication channels, recording devices or databases. In an embodiment, the input signal can be received from portable devices, microphones, storage devices, communication channels, and so on. At operation 302, a signal block is classified as a silent or non-silent block using feature parameters extracted from the signal block. At operation 303, a total variation filtering on a non-silent signal block is applied with a desired regularization parameter that can be used for speech enhancement by smoothing out background noises and preserving high-slopes of voice components. In an embodiment, the total variation filtering prevents pitch doubling and pitch halving errors which may be introduced due to variations of a phoneme level and prominent slowly varying wave components between two pitch peak portions.

At operation 304, the filtered signal is divided into signal frames and at operation 305 the signal frames are classified as a silent or non-silent frame using feature parameters extracted from the signal frame and the total variation residual under a wide range of background noises encountered in real world applications. At operation 306, binary values generated for the voice/non-voice signal classification process are stored (e.g., 1: Voice and 0: Non-voice). At operation 307, merging and deleting of a signal frame using the duration information by processing the binary sequence information obtained for each signal block takes place. At operation 308, the endpoint of a voice signal is determined by using the binary sequence information and energy envelope information. Further, at operation 309, correcting the endpoints using the feature parameter made from a portion of signal samples extracted from the endpoint determined at the previous steps takes place. At operation 310, executing the voice end point information or the input signal with voice endpoint information, to the speech related technologies and systems takes place. The various actions in method 300 may be performed in the order presented, in a different order or simultaneously. Further, in some embodiments, some actions illustrated in FIG. 3 may be omitted.

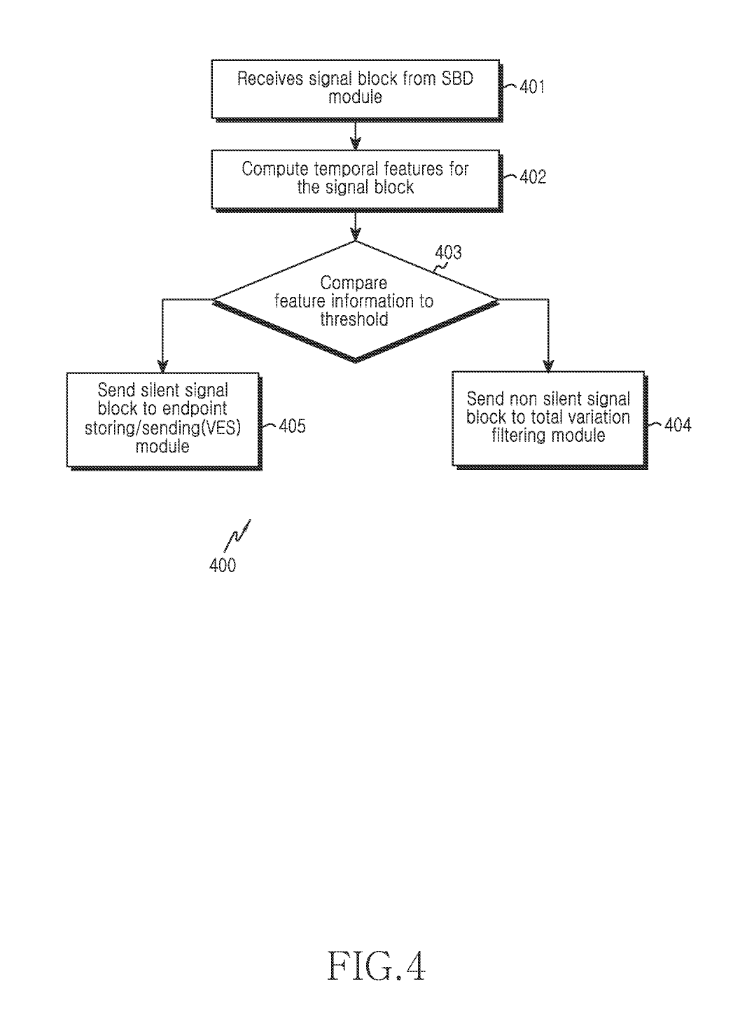

FIG. 4 illustrates a flow diagram explaining a method for determining a silent signal block and a non-silent block in accordance with various embodiments of the present disclosure.

Referring to FIG. 4, at operation 401, the signal block from the SBD module 201 is received. At operation 402, temporal features are computed for the signal block. At operation 403, the feature information is compared to thresholds. At operation 404, a check is performed to determine whether feature information is greater than the threshold. If the feature information is greater than the threshold, then the signal block is considered as non-silent and the silent signal block is sent to the total variation filtering module 203 in step 404. If the feature information is smaller than the threshold, then the signal block is considered silent and the silent block is sent to the VES module 206 in step 405.

In an embodiment, the SNBC module 202 includes means for receiving an input signal block from a memory buffer, means for determining temporal feature parameters from the received signal block, means for determining silent blocks by comparing the extracted temporal feature parameters to the thresholds, means for determining endpoints of a non-silent signal block, and means for generating action variable information to send the signal block either to the VES module 206 or to the total variation filtering module 203.

Further, the SNBC module 202 is constructed using a Hierarchical Decision-Tree (HDT) scheme with a threshold. The SBD module 201 extracts the one or more temporal features (e.g., energy, zero crossing rate, and energy envelope) from an input signal block received from the SBD module 201. The temporal features may represent the various nature of an audio signal that can be used to classify the input signal block. The HDT uses the feature information extracted from the input signal block and a threshold for detecting a silent signal block. The HDT sends a signal block, as an output, to the total variation filtering module 203 only when the feature information of a signal block will be equal to or greater than the threshold. The method provides SFD for dividing a total variation filtered signal into consecutive signal frames.

The SFD module 205 receives a filtered signal block from the TVF module 203 and divides a received filtered signal into equal-sized overlapping short signal frames with frame length of L samples. The frame length and the frame shift are adopted based on the system requirements. The SFD module 205 sends a signal frame to the SNFC module 208 according to the action variable information received from the succeeding modules. In another aspect of HDT, the decision stage considers the signal block as a silent block when the feature information will be smaller than a threshold. In such a scenario, the SNBC module 202 directly sends action variable information to the VES module 206 without sending the action variable information to the other signal processing units. The main objective of preferred SNBC module 202 is to reduce computational cost and power consumption. In the SNBC module 202, a long silent interval frequently occurs between two successive voice signal portions. The various actions in method 400 may be performed in the order presented, in a different order or simultaneously. Further, in some embodiments, some actions listed in FIG. 4 may be omitted.

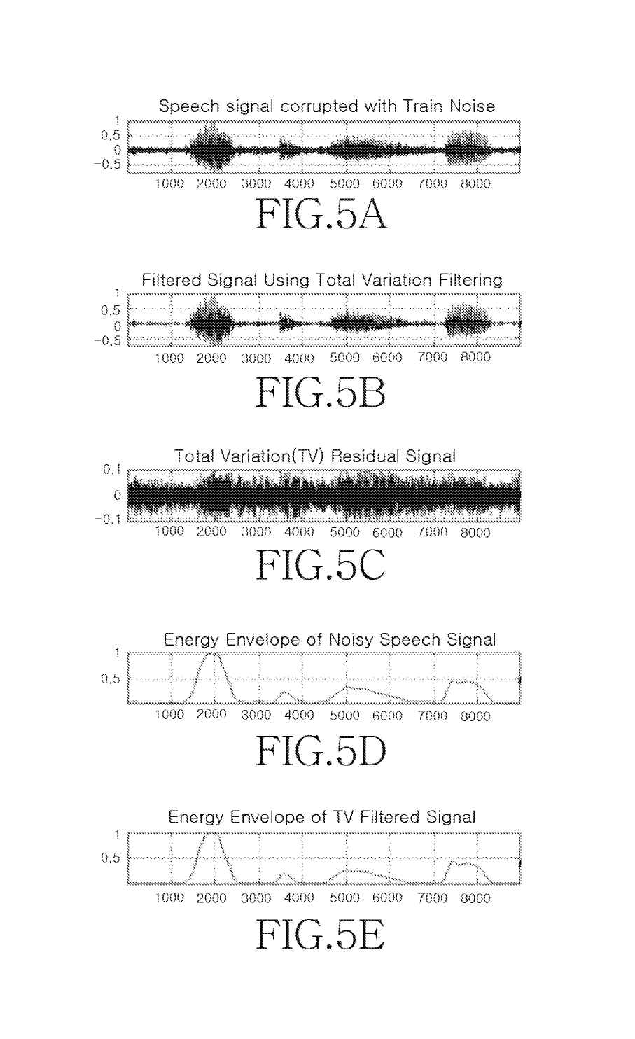

FIGS. 5A to 5E illustrate graphs indicating effectiveness of total variation filtering under a realistic noise environment in accordance with various embodiments of the present disclosure.

Referring to FIGS. 5A to 5E, the graphs illustrate that an input speech signal is corrupted by train noise. FIG. 5A is a first plot depicting a speech signal corrupted with train noise. FIG. 5B is a second plot depicting an output of a total variation filter that is the filtered signal using total variation filtering. FIG. 5C is a third plot depicting a residual signal obtained between the input signal and the total variation filtered signal. FIG. 5D is a fourth plot depicting a normalized energy envelope obtained for the input signal. FIG. 5E is a fifth plot depicting a normalized energy envelope obtained for the total variation filtered signal.

The total variation filtering technique is a process often used in digital image processing that has applications in noise removal. Total variation filtering is based on the principle that signals with excessive and possibly spurious details have high total variation, that is, the integral of the absolute gradient of the signal is high.

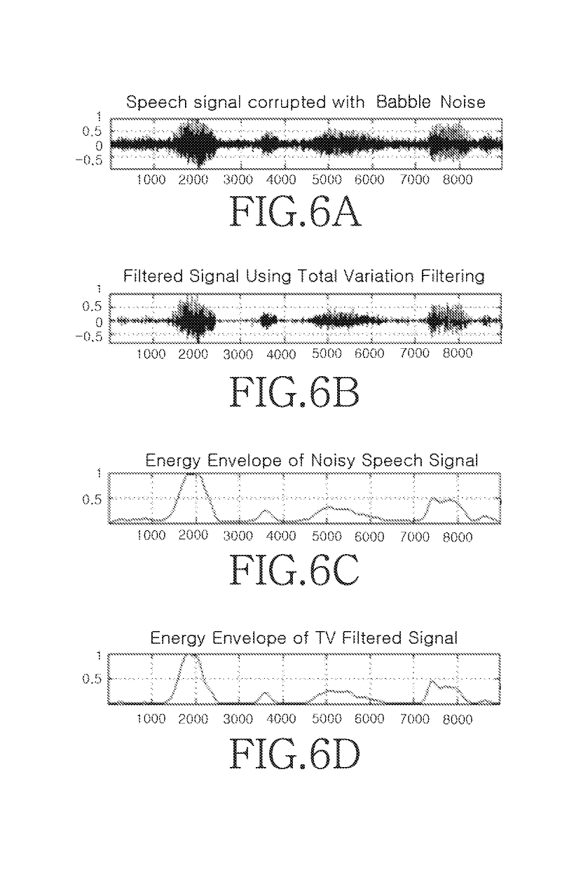

FIGS. 6A to 6D illustrate graphs indicating effectiveness of total variation filtering for a speech signal corrupted by babble noise with varying noise levels in accordance with various embodiments of the present disclosure.

Referring to FIGS. 6A to 6D, FIG. 6A is a first plot indicating a speech signal corrupted with babble noise. FIG. 6B is a second plot indicating a filtered signal using total variation filtering. FIG. 6C is a third plot indicating an energy envelope of a noisy speech signal. The energy envelope shown in the third plot illustrates the limitations of the energy threshold based existing VAD systems. FIG. 6D is a fourth plot indicating an energy envelope of a total variation filtered signal. Experimental results in FIG. 6D demonstrate that the total variation filtering process may provide an excellent feature for more accurate detection and determination of endpoints of speech regions.

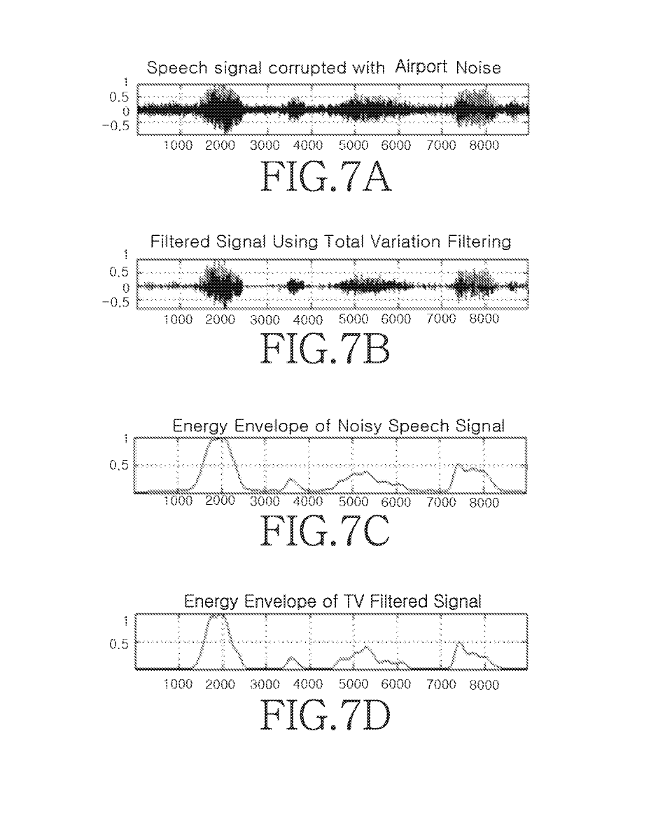

FIGS. 7A to 7D illustrate graphs indicating effectiveness of total variation filtering for a speech signal corrupted by airport noise in accordance with various embodiments of the present disclosure.

Referring to FIGS. 7A to 7D, under varying noise levels, the total variation filtering technique leads to provision of a robust system for more accurately detecting a voice signal activity period that can reduce the total number of false and missed detections by maintaining the energy level (or noise floor or magnitude) of a non-voice signal portion even in varying background noise levels. From the experimental results, it can be observed that the system with a total variation filtered signal can produce better detection rates by using noise floor (or level) estimates measured from the total variation residual which is obtained between the original and total variation filtered signals. The VAD system processes and extracts feature parameters from both total variation filtered and total variation residual signals. The feature extraction from the total variation filtered signal may increase the robustness of the features and thus improves overall detection accuracy under different adverse conditions.

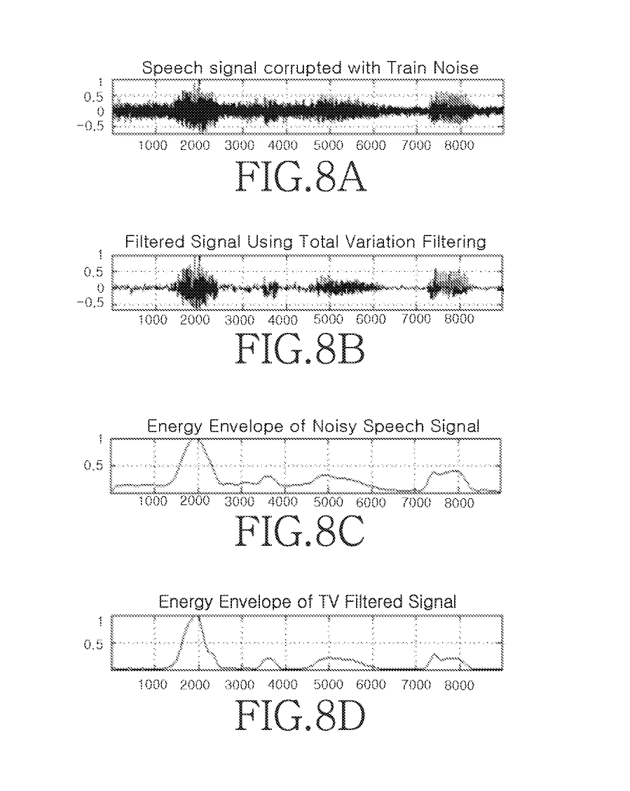

FIG. 8A to 8D illustrate graphs indicating noise-reduction capability of total variation filtering for a speech signal corrupted by time-varying levels of additive white Gaussian noise in accordance with various embodiments of the present disclosure.

FIG. 8A is a first plot indicating a speech signal corrupted with Additive White Gaussian Noise (AWGN). FIG. 8B is a second plot indicating a filtered signal using total variation filtering. FIG. 8C is a third plot indicating an energy envelope of a noisy speech signal. FIG. 8D is a fourth plot indicating an energy envelope of a total variation filtered signal. The normalized energy envelope signals obtained for the input signal and the total variation filtered signal are shown in the FIG. 8C and FIG. 8D respectively. It can be noticed that the total variation filtering method provides better reduction of noise components. By using an optimal energy threshold parameter, the total variation filtered signal can provide significantly better detection rates since the effect of time varying noise is reduced significantly.

The experimental results on different noise types demonstrate that the total variation filtering technique can address the robustness of the traditional features. The capabilities of the total variation filtering technique can be observed from the energy envelopes extracted from the noisy signal and the total variation filtered signal.

Further, the total variation filtering technique improves the noise-reduction as compared to existing filtering techniques even if the input signal is a mixture of different background noise sources at varying amplitude levels, low-frequency voiced speech portions, and unvoiced portions, which often reduces the detection rates in most of the voice activity detection systems published based on the prior art techniques. The main advantage of using the total variation smoothing filter is that it preserves speech properties of interest in a different manner than conventional filtering techniques used for suppressing noise components.

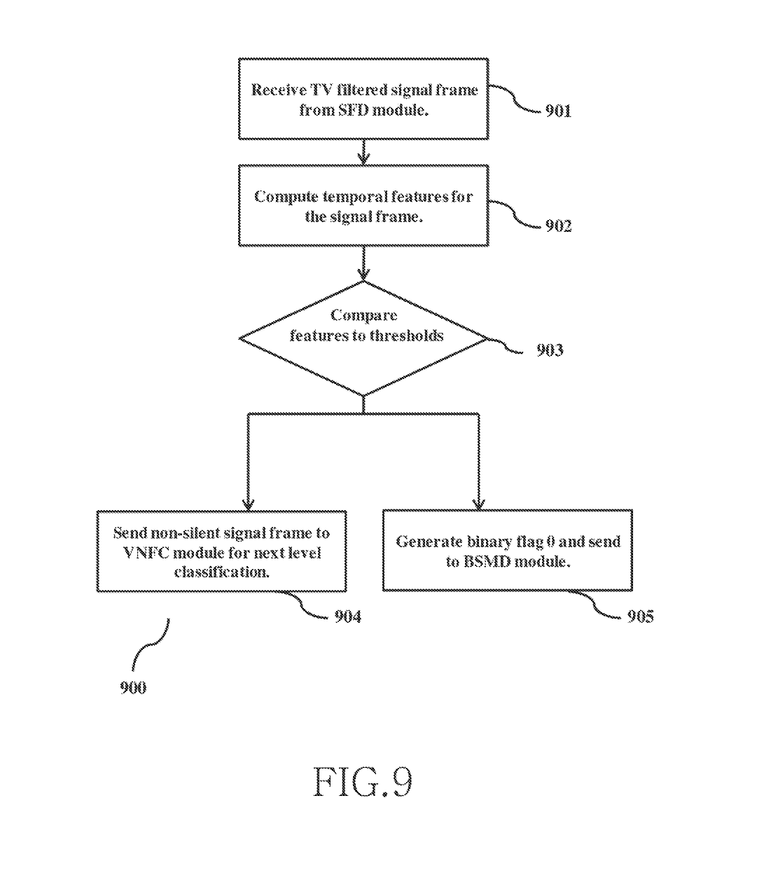

FIG. 9 illustrates a flow diagram explaining a process for determining SNFC in accordance with various embodiments of the present disclosure.

Referring to FIG. 9, FIG. 900 includes operation 901 at which the SNFC module 208 receives the total variation filtered signal frame from SFD module 205 and computes the temporal features for the signal frame at operation 902. The SNFC module 208 compares the features to thresholds at operation 903. Based on instructions, the hierarchical decision-tree sends the signal frame, as an output, to the VNFC module 207 only when feature information fully satisfies logical statements with thresholds. Otherwise, the decision tree considers a signal frame as a silent frame when feature information may fail to satisfy logical statements with thresholds at operation 904. In this scenario, the SNFC module 208 generates binary-flag information which provides assignment statements of logical expressions or using if-then statements at operation 905.

The SNFC module 208 comprises means for receiving total variation filtered signal frames, means for extracting temporal feature information from each signal frame, means for determining silent signal frames by comparing extracted feature information to thresholds, means for determining binary-flag information (e.g., 1:non-silent signal frame and 0:silent signal frame), and means for generating action variable information to send the signal block either to a VNFC module or to a BSMD module. The main objective of the SNFC module 208 is to reduce computational cost and power consumption where a silent portion frequently occurs between voice signal portions. Further, the SNFC module 208 with total variation filter feature information provides better discrimination of silent signal frames from non-silent signal frames.

The binary-flag information may include binary values of 0 (i.e., a False Statement) and 1 (i.e., a True Statement). Further, the decision tree of the HDT sends the binary-flag information value of 0, as an output, to a BSMD module without sending the signal frame to the VNFC module 207 for further signal processing. Otherwise, the input signal frame is further processed at the VNFC module 207 only when feature information extracted from the input signal frame is equal to or greater than thresholds. The various actions in method 900 may be performed in the order presented, in a different order or simultaneously. Further, in some embodiments, some actions listed in FIG. 9 may be omitted.

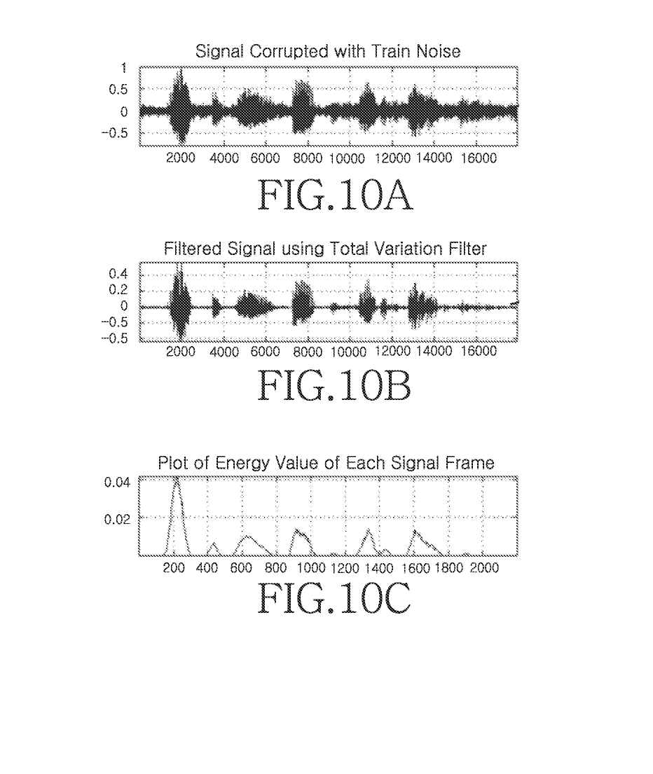

FIGS. 10A to 10C illustrate graphs which indicating experimental results of SNFC in accordance with various embodiments of the present disclosure.

Referring to FIGS. 10A to 10C, experimental results show that a total variation filtering method provides an enhanced energy feature for reducing the computational load of further processing systems by eliminating signal frames in silent regions without substantially missing the speech regions. As depicted in the graphs, signal frames in silent regions are marked with a magnitude of zero in the third plot.

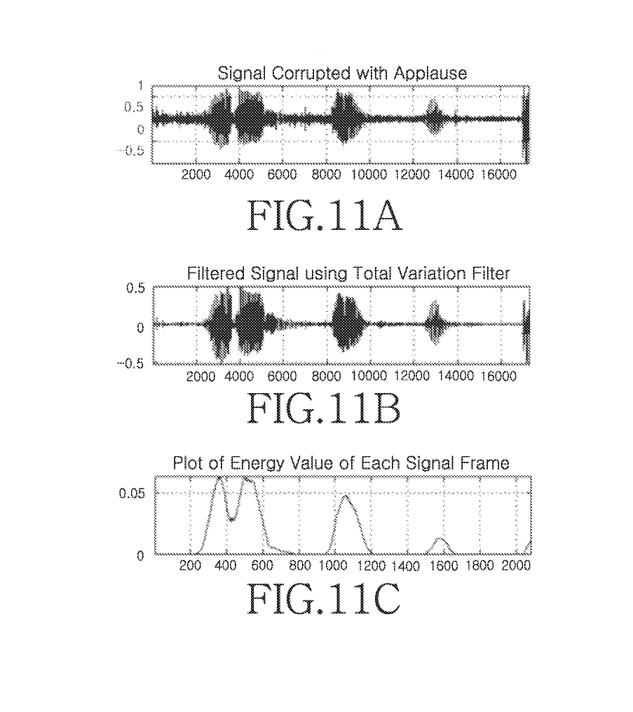

FIGS. 11A to 11C illustrate graphs indicating experimental results of SNFC in accordance with various embodiments of the present disclosure.

Referring to FIGS. 11A to 11C, the total variation filtered signal for an input speech signal corrupted by applause sound is shown in the second plot. The output of the SFC module is shown in the third plot. It can be noticed that the total variation filtering method significantly reduces the effect of applause sounds without distorting the shape of the envelope and essential features used for detecting voiced speech regions. The result shows that the SFC module can decrease the computational load by discarding the signal frames which have very low energy value.

From FIGS. 10A to 10C and FIGS. 11A to 11C, the first graphical plot of both figures represents the noisy speech signal corrupted by train noise and applause respectively, wherein the x-axis represents the sample number while the y-axis represents the amplitude of a discrete sample. The second graphical plot represents the filtered signal by using a total variation filter. The third graphical plot represents the threshold energy envelope obtained by combining the results of all the signal frames. Experiment shows that the total variation filtering method provides an energy feature for reducing the computational load of further processing systems by eliminating signal frames in silent regions without substantially missing the speech regions. The signal frames in silent regions are marked with a magnitude of zero in the third plot.

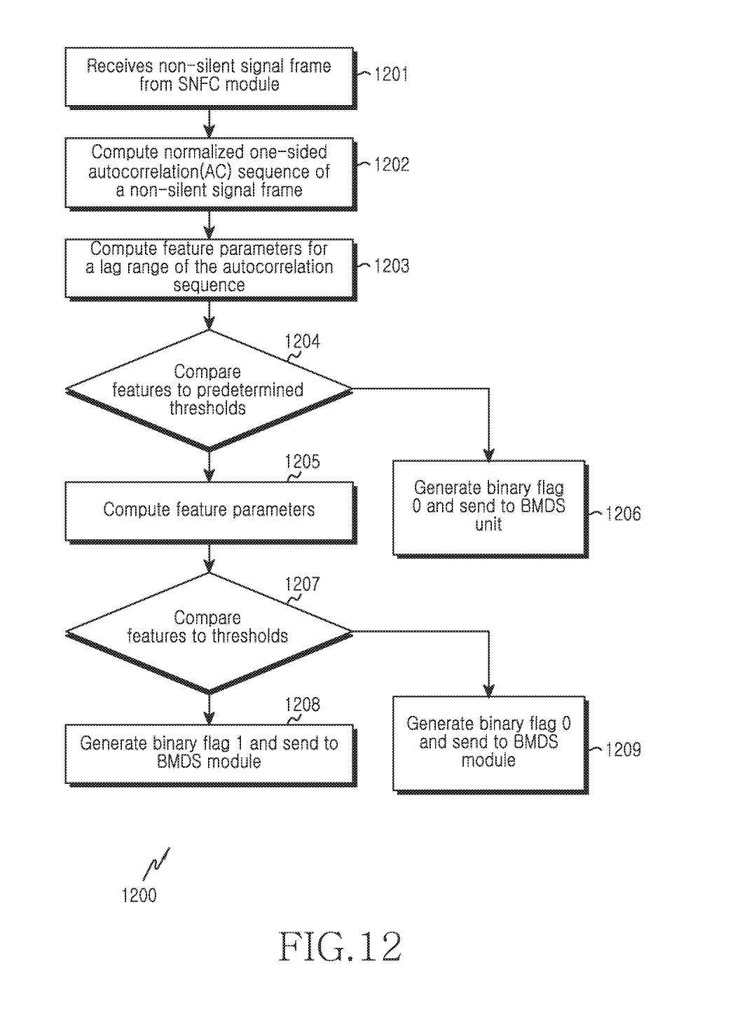

FIG. 12 illustrates a flow diagram explaining a VNFC in accordance with various embodiments of the present disclosure.

Referring to FIG. 12, operation 1201 of FIG. 1200 illustrates that the VNFC module 207 receives a non-silent signal frame from the SNFC module 208. The VNFC module 207 computes a normalized one-sided AutoCorrelation (AC) sequence of a non-silent signal frame at operation 1202. Further, the VNFC module 207 computes feature parameters such as a lag index of a first zero crossing point, a zero crossing rate, a lag index of a minimum point, and an amplitude of a minimum point for a predefined lag range of the autocorrelation sequence at operation 1203. The VNFC module 207 compares features to thresholds at operation 1204. The VNFC module 207 computes feature parameters for a predefined lag range of the autocorrelation sequence at operation 1205. Further, the VNFC module 207 generates binary flag information which is sent to the BMDS module at operation 1206. The VNFC module 207 compares features to thresholds at operation 1207. Further, the VNFC module 207 initially generates binary flag 1 information at operation 1208 and generates binary flag 0 information which is sent to the BMDS module at operation 1209.

The VNFC module 207 includes means for receiving a non-silent signal frame from the signal frame classification module, means for computing normalized one-sided autocorrelation of a non-silent signal frame, means for extracting autocorrelation feature information, means for determining a voice signal frame and a non-voice signal frame based on the extracted total variation residual and autocorrelation features by comparing features to thresholds, means for generating action variable information to send the voice signal frame to a BSMD module and to control a voice activity detection process. The VNFC module 207 classifies an input non-silence signal frame into a voice signal frame and a non-voice signal frame. Based on the classification results, the VNFC module 207 generates binary-flag information (e.g., binary-flag 0 for non-voice signal frame and binary-flag 1 for voice signal frame) to determine the endpoint of the voice signal activity portion.

The VNFC module 207 includes three major methods such as autocorrelation computation, feature extraction, and decision. The classification method is implemented using a multi-stage HDT scheme with thresholds. The flowchart configuration of the multi-stage HDT can be redesigned according to the computation complexity and memory space involved in extracting feature parameters from the autocorrelation sequence of the non-silence signal frame.

In an embodiment, the VNFC module 207 first receives a non-silence signal frame with a number of signal samples. The VNFC module 207 then computes normalized one-sided autocorrelation of a non-silence signal frame represented as d[n]. The autocorrelation of the signal frame d[n] with length of N samples is computed using Equation (1):

$$r [ k ] = \frac{1}{N} {\sum }_{n = 0}^{N - 1} d [ n ] d [ n + k ] \qquad Equation ( 1 )$$

In Equation (1), r denotes the autocorrelation sequence, and k denotes the lag of the autocorrelation sequence.

The feature information from the autocorrelation sequence is used to characterize signal frames. The periodicity feature of the autocorrelation may provide temporal and spectral characteristics of a signal to be processed. For example, the periodicity in the autocorrelation sequence indicates that the signal is periodic. The autocorrelation function falls to zero for highly non-stationary signals. The voiced speech sound is periodically correlated and other background sounds from noise sources are not (or uncorrelated). If a frame of a voiced sound signal is periodically correlated (or a quasi-periodic), its autocorrelation function has the maximum peak value at the location of pitch period of a voiced sound. In general, the autocorrelation function demonstrates the maximum peak within the lag value range corresponding to the expected pitch periods of 2 to 20 ms for voiced sounds. The conventional voiced activity detection considers that voiced speech may have a higher maximum autocorrelation peak value than the background noise frames. In an embodiment, the maximum autocorrelation peak value may be diminished and the autocorrelation lag of the maximum peak may deviate from the threshold range due to phoneme variations and different background sources including applause, laughter, car, train, crowd cheer, babble, thermal noise, and so on. The feature parameters that are extracted from the autocorrelation of the total variation filtered signal can have the ability to increase the robustness of the VAD process.

Further, the VNFC module 207 extracts the feature information comprising an autocorrelation lag index (or time lag) of a first zero crossing point of the autocorrelation function, a lag index of a minimum point of the autocorrelation function, an amplitude of a minimum point of the autocorrelation function, lag indices of local maxima points of the autocorrelation function, amplitudes of local maxima points, and decaying energy ratios. The extraction of feature information is done in a sequential manner according to the heuristic decision rules followed in the preferred HDT scheme.

The lag index (or time lag) of the first zero crossing point is used to characterize the frames with highly non-stationary noises (or transients). From various experimental results, it is noted that the value lag index of the first zero crossing point of the autocorrelation sequence is less than the lag value of 4 for several types of noises.

The proposed method uses the lag index of the first zero crossing point feature to detect the noise frames. For a given autocorrelation sequence with a certain number of coefficients, the first zero crossing point is described as in Equation (2):

fzcp₁=first_zcp(r[m]), 0≦m≦UL₁ Equation (2)

In Equation (2), first_zcp(·) is the function that provides the lag index of the first zero crossing point (fzcp1), m denotes the autocorrelation lag index variable, and UL₁ denotes the upper lag index value.

The proposed method performs the determination of a lag index of the first zero crossing point within a new autocorrelation sequence constructed with a certain number of autocorrelation values. Thus, the proposed method may reduce the computational cost of the feature extraction by examining only a few autocorrelation sequence values. In addition, the power consumption, computational load and memory consumption may be reduced when a particular type of noise constantly occurs.

For a given range of an autocorrelation sequence, the lag index and amplitude of the minimum peak are computed using Equation (3):

[rₘᵢₙ_{_{—}}ₐₘₚrₘᵢₙ_{_{—}}_{lag}]=min_amp_lag(r[m]), LL₂≦m≦UL₂ Equation (3)

In Equation (3), min_amp_lag(·) is the function which computes the minimum amplitude (rₘᵢₙ_{_{—}}amp) and its lag index (rᵢₙ_{_{—}}_{lag}), and m is the autocorrelation lag variable. LL₂ denotes the lower lag index value, and UL₂ denotes the upper lag index value.

In an embodiment, the lag index and amplitude of the minimum peak features are extracted from the autocorrelation sequence within a lag interval. These features are used to identify the types of noise signals having periodic structure components.

The proposed method includes extraction of the lag index and amplitude of the maximum peak of the autocorrelation sequence within a lag interval. These features are used to represent a voiced speech sound frame. The lag and maximum peak thresholds are used to distinguish voiced sound from other background sounds. For a given range of autocorrelation coefficients, the lag index and amplitude of the minimum peak are computed using Equation (4):

[rₘₐₓ_{_{—}}ₐₘₚtₘₐₓ_{_{—}}_{lag}]=max_amp_lag(r[m]), LL₃≦m≦UL₃ Equation (4)

In Equation (4), max_amp_lag(·) is the function that outputs the maximum amplitude (rₘₐₓ_{_{—}}ₐₘₚ) and its lag index (rₘₐₓ_{_{—}}_{lag}).

The proposed method utilizes the peak amplitude and its lag index information for reducing the computational cost of a VAD system by eliminating highly non-stationary noise frames having different noise levels. In order to reduce the number of noise frame detections, the proposed method uses decaying energy ratios.

In certain implementations, the feature extraction method computes decaying energy ratios by dividing the autocorrelation sequence into unequal blocks. For a given block of autocorrelation sequence, the autocorrelation energy decaying ratio (i) is computed using Equation (5):

$${τ}_{i} = \frac{{\sum }_{k = {L}_{i}}^{{U}_{i}} {r}^{2} [ k ]}{{\sum }_{k = 0}^{N - 1} {r}^{2} [ k ]} \qquad Equation ( 5 )$$

In Equation (5), τᵢ denotes the i^{th} decaying energy ratio computed for autocorrelation lag index ranging from Lᵢ and Uᵢ. N denotes the total number of autocorrelation coefficients and k denotes the autocorrelation lag variable.

Further, the decaying energy ratio lies between 0 and 1 and is a representative feature for distinguishing the voiced sounds from the background sounds, and noises. In most sound frames, the decaying energy ratios in the autocorrelation domain computed in the method described above can demonstrate a high robustness against a wide variety of background sounds and noises. In addition, the decaying energy ratios are computed in a computationally efficient manner.

In an embodiment, the method of constructing a decision tree takes the computational cost of each feature into consideration.

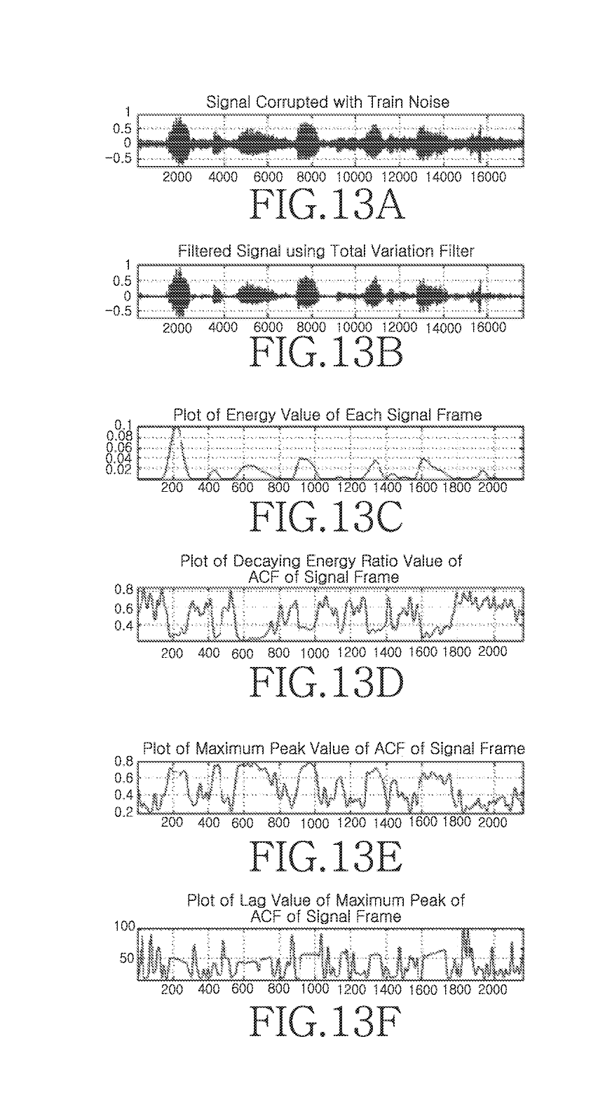

FIG. 13A to 13F illustrate graphs indicating patterns of features extracted from autocorrelation of a total variation filtered signal in accordance with various embodiments of the present disclosure.

FIG. 13A is a first plot depicting a signal corrupted with train noise.

FIG. 13B is a second plot depicting a filtered signal using a total variation filter. FIG. 13C is a third plot depicting an energy value of each signal frame. FIG. 13D is a fourth plot depicting a decaying energy ratio value of an AutoCorrelation Function (ACF) of a signal frame. FIG. 13E is a fifth plot depicting a maximum peak value of an ACF of the signal frame. FIG. 13F is a sixth plot depicting a lag value of a maximum peak of an ACF of the frame. The graphical plots of feature patterns are shown to illustrate the effectiveness in distinguishing a voice signal frame from a non-voice signal frame by using total variation autocorrelation feature information.

Further, from FIG. 12, the VNFC module 207 includes configurable feature extraction methods that may extract feature parameters. The extracted feature parameters are used as the input to the internal decision statement or logical expressions described in accordance with the proposed method. The configuration of the feature extraction methods may be modified in different ways.

In a proposed method, each feature extraction method receives the autocorrelation sequence with a number of autocorrelation coefficient values. The feature extraction method processes the input data according to the action variable information. Finally, the VNFC module 207 of the proposed method generates binary flag information (e.g., binary flag 0 for non-voice signal frame, and binary flag 1 for voice signal frame) and sends flag information to a BSMD module. The plots of feature patterns are shown for a comprehensive understanding and illustrating of the effectiveness in distinguishing a voice signal frame from a non-voice signal frame by using total variation autocorrelation feature information.

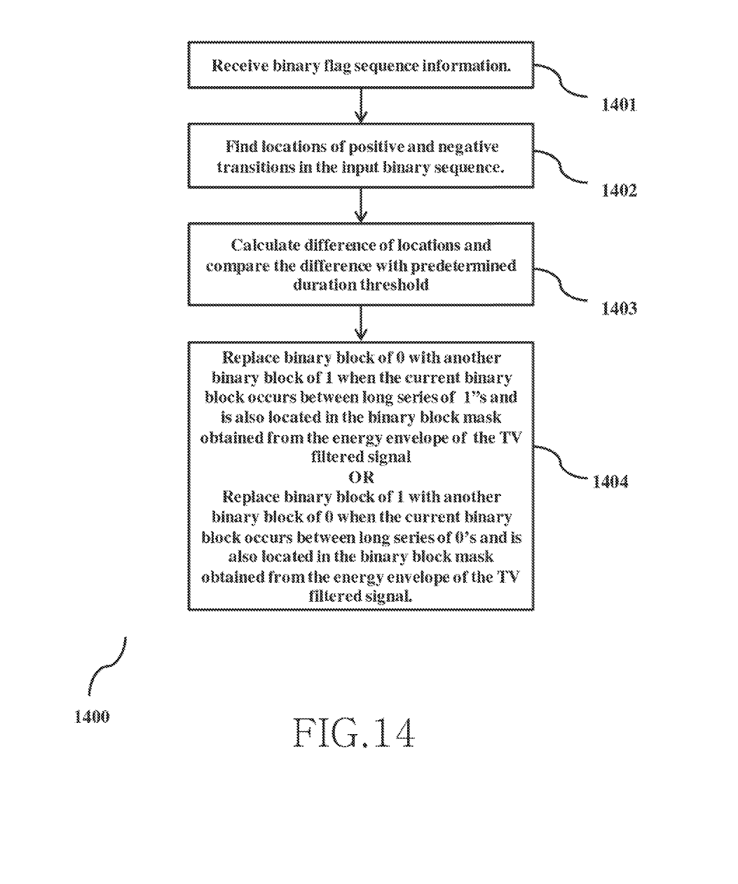

FIG. 14 illustrates a flow diagram explaining a process of BSMD according to various embodiments of the present disclosure. The merging operation is also referred to as insertion (or inclusion or addition).

Referring to the FIG. 14, the BSMD module 210 processes the binary-flag sequence generated for each non-silence signal block by way of flow diagram 1400. The binary-flag sequence comprises binary-flag 1 and binary-flag 0 values for a detected voice signal frame and non-voice signal frame, respectively. At operation 1401, binary flag sequence information is received and at operation 1402, locations of positive transitions (0 to 1) and negative transitions (1 to 0) in the input binary sequences are found. Further, at operation 1403 the differences of locations are calculated and compared with the duration threshold. At operation 1404, the binary block of 0 is replaced with another binary block of 1. This process happens when the current binary block occurs between long series of 1's which is also located in the binary block mask obtained from the energy envelope of the total variation filtered signal. Operation 1404 can also occur when the binary block of 1 is replaced with another binary block of 0, that is when the current binary block occurs between long series of 0's and is also located in the binary block mask obtained from the energy envelope of the total variation filtered signal.

Based on the overlapping frame concept in VAD, the total number of missed and false signal frame detections may be reduced by using the information of possible duration of voiced speech regions. Further, in certain embodiments, the proposed method employs the minimum voiced speech duration and the interval between two successive voice signal portions. In an embodiment, the VAD system determines the feature smoothing process which can reduce the number of false and missed detections. In an embodiment, the VAD system may optionally configure the construction of embodiments depending on the applications. The mode of VAD triggering can be manually or automatically selected by a user. In a power saving mode, VAD applications may be disabled.

According to the disclosure, the method of merging replaces binary-flag 0 by binary-flag 1 when it identifies the binary-flag 0 for the signal frames within an interval from the previous endpoint of a voiced speech portion. In another aspect, the binary-flag 1 is replaced by binary-flag 0 when the signal frames detected as a voice signal frame within long zeros on both left and right sides of the detected voice signal frames with a total duration is less than the duration threshold.

In certain embodiments, the binary-flag merging/deletion is performed by using a set of instructions that counts the total numbers of series of ones and zeros, and also continuously compares count values with the thresholds. From various experiments, it was noticed that the merging and deletion methods of the proposed method may provide significantly better endpoint detection results. The main objective of the preferred method of merging is to avoid a discontinuity effect that is introduced due to the elimination of a set of signal samples of a single spoken word during the voice and non-voice classification process.

The main objective of the method of deletion is to remove a short-burst of some types of sounds that are falsely detected. Further, the VEDC is designed for accurately determining the endpoint (or boundary or onset/offset) of a voice signal portion and correcting using the feature information extracted from each sub-frame of the signal samples. The various actions in flowchart 1400 may be performed in the order presented, in a different order or simultaneously. Further, in some embodiments, some actions listed in FIG. 14 may be omitted.

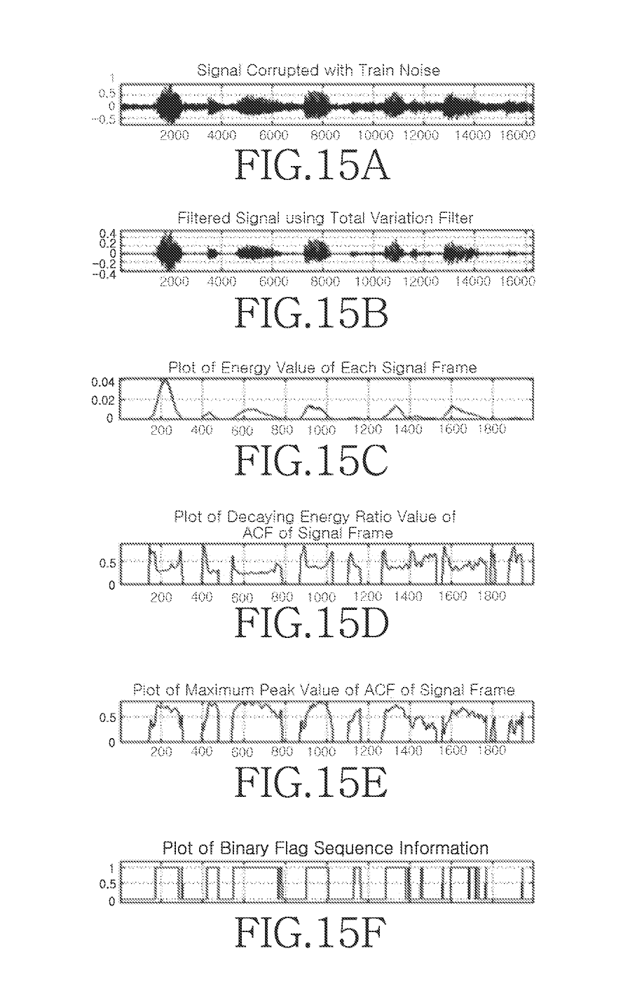

FIGS. 15A to 15F illustrate graphs indicating outputs of speech corrupted by train noise in accordance with various embodiments of the present disclosure.

FIG. 15A is a first plot depicting a signal corrupted with train noise. FIG. 15B is a second plot depicting a filtered signal using a total variation filter. FIG. 15B demonstrates the performance of the TVF module 203. FIG. 15C is a third plot depicting an energy value of each signal frame. FIG. 15C depicts an output of the SFC module 208 with temporal feature information. FIG. 15D is a fourth plot depicting a decaying energy ratio value of an ACF of a signal frame. FIG. 15E is a fifth plot depicting a maximum peak value of an ACF of the signal frame. The outputs obtained by comparing feature information with thresholds are shown in FIG. 15D and FIG. 15E. FIG. 15F is a sixth plot depicting binary flag sequence information. FIG. 15F is a voice/non-voice classification result obtained by comparing both decaying energy ratio and the maximum peak values with thresholds.

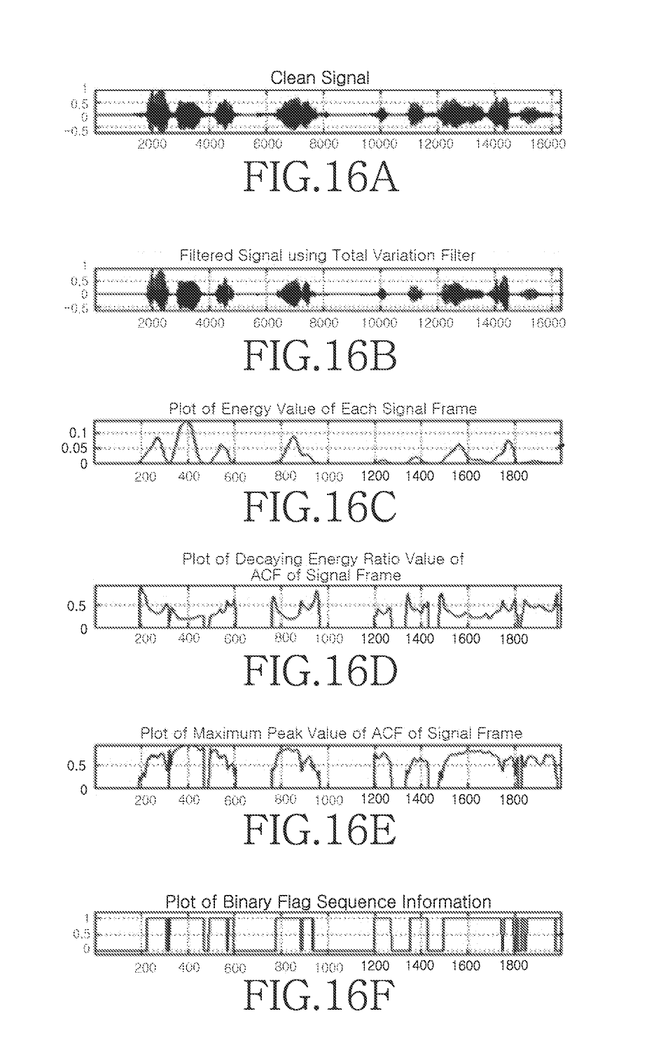

FIGS. 16A to 16F illustrate graphs indicating outputs for a clean speech signal in accordance with various embodiments of the present disclosure.

FIG. 16A is a first plot depicting a clean signal. FIG. 16B is a second plot depicting a filtered signal using a total variation filter. FIG. 16B demonstrates the performance of a total variation filtering module. FIG. 16C is a third plot depicting an energy value of each signal frame. FIG. 16C is the output of an SFC module with temporal feature information. FIG. 16D is a fourth plot depicting the decaying energy ratio value of an ACF of a signal frame. FIG. 16E is a fifth plot depicting a maximum peak value of an ACF of the signal frame. The outputs obtained by comparing feature information with thresholds are shown in FIG. 16D and FIG. 16E. FIG. 16F is a sixth plot depicting binary flag sequence information. FIG. 16F is a voice/non-voice classification result obtained by comparing both the decaying energy ratio and the maximum peak values with thresholds.

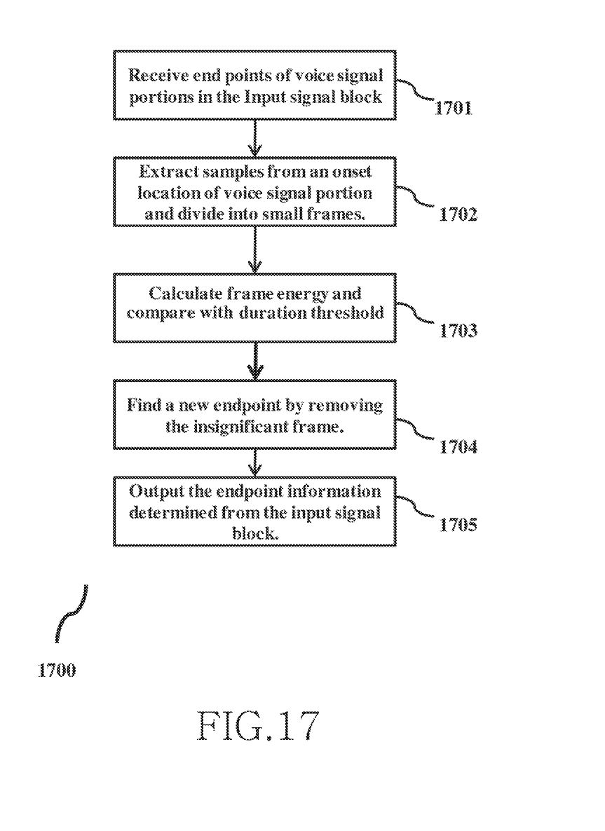

FIG. 17 illustrates a flow diagram explaining a process of VEDC according to various embodiments of the present disclosure.

Referring to FIG. 17, a VEDC module is designed for more accurately determining and correcting the endpoint (or boundary or onset/offset) of a voice signal portion using the feature information extracted from each sub-frame of the signal samples. As depicted in flow diagram 1700 of FIG. 17, initially the VEDC module receives endpoints (i.e., onset and offset) of voice signal portions in the input signal block at operation 1701 and extracts samples from an onset (or offset) location of a voice signal portion and divides them into small frames at operation 1702. Further, the VEDC module calculates the frame energy and compares the calculated frame energy with a duration threshold at operation 1703. The VEDC module finds a new endpoint (onset and offset) by removing an insignificant frame at operation 1704 and outputs the endpoint information determined from the input signal block at operation 1705.

The VEDC module provides endpoint determination, signal framing, feature extraction and endpoint correction. The endpoints of all detected voiced signal portions are computed by processing the binary-flag sequence information and the values of frame length and frame shift. Further, the VEDC module provides endpoints in terms of either a sample index number or a sample time measured in milliseconds.

In an embodiment, the endpoint is corrected using a simple feature extraction and a threshold rule. During correction, processing of the signal frame is performed with a number of signal samples. The signal frame is extracted at the onset and offset of each voiced speech portion. During endpoint correction the signal frame is first divided into non-overlapping small frames. Then, the computation of energy of each sub-frame takes place and is finally compared with a threshold. The proposed method may provide an accurate determination of endpoints of voiced signal portions when the recorded/received audio signal with high signal-to-noise ratio mostly occurs in many realistic environments. The various actions in method 1700 may be performed in the order presented, in a different order or simultaneously. Further, in some embodiments, some actions listed in FIG. 17 may be omitted.

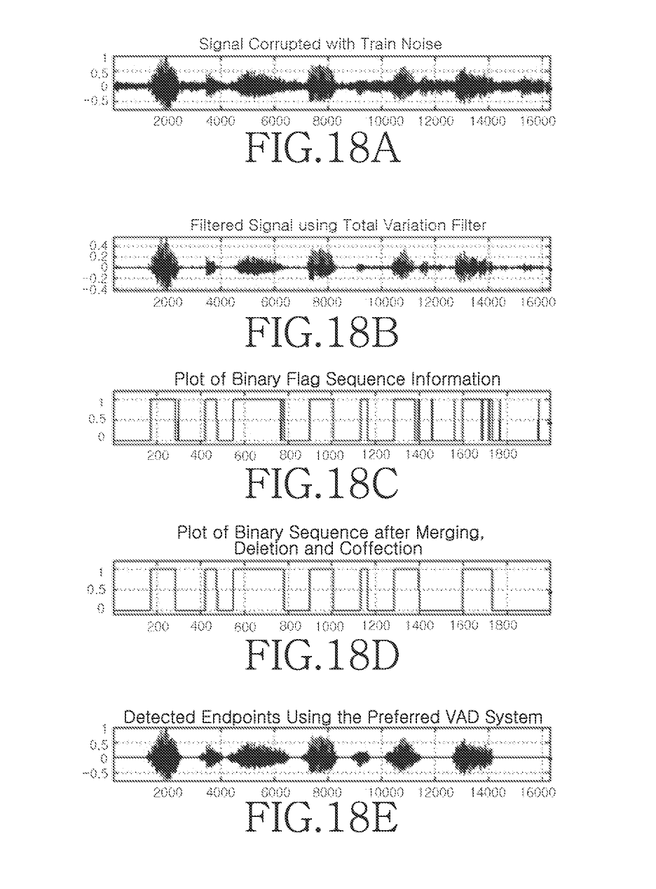

FIGS. 18A to 18E illustrate graphs indicating outputs of a VNFC module, a BSMD module and a VEDC module in accordance with various embodiments of the present disclosure.

FIG. 18A is a first plot depicting a signal corrupted with train noise. FIG. 18B is a second plot depicting a filtered signal using a total variation filter. FIG. 18C is a third plot depicting binary flag sequence information. FIG. 18C shows the output of a VNFC module. FIG. 18D is a fourth plot depicting the binary sequence after merging, deletion and correction. FIG. 18D shows the output of a BSMD module. FIG. 18E is a fifth plot depicting detected endpoints using a VAD system. FIG. 18E demonstrates the output of the VEDC module. The endpoints of a voice signal portions are marked as circles.

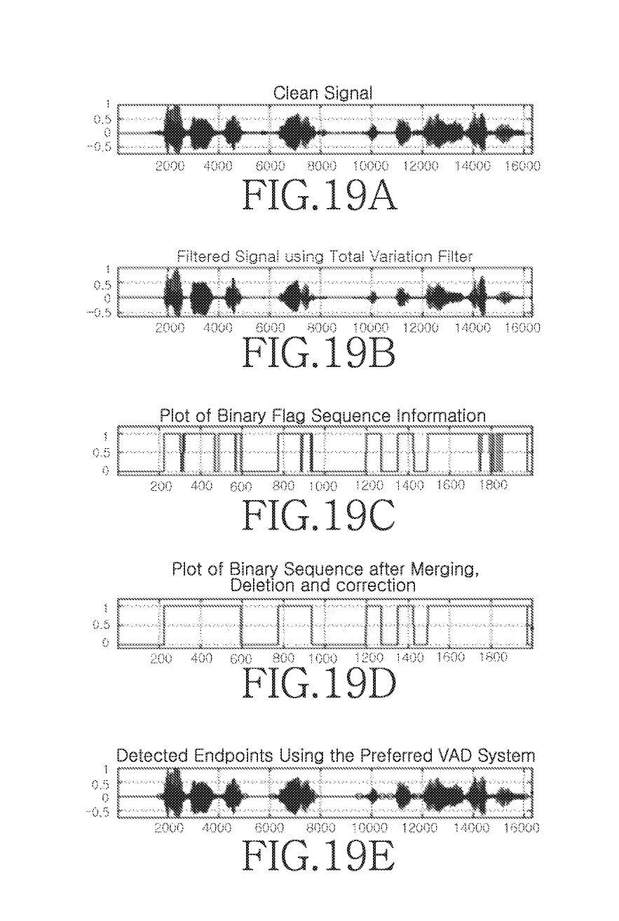

FIGS. 19A to 19E illustrate graphs indicating outputs of a VNFC module, a BSMD module and a VEDC module in accordance with various embodiments of the present invention.

FIG. 19A is a first plot depicting a clean signal. FIG. 19B is a second plot depicting a filtered signal using a total variation filter. FIG. 19C is a third plot depicting binary flag sequence information. FIG. 19C shows the output of a VNFC module. FIG. 19D is a fourth plot depicting binary sequences after merging, deletion and correction. FIG. 19D shows the output of a BSMD module. FIG. 19E is a fifth plot depicting detected endpoints using a VAD system. FIG. 19E demonstrates the output of a VEDC module. The endpoints of a voice signal portions are marked as circles.

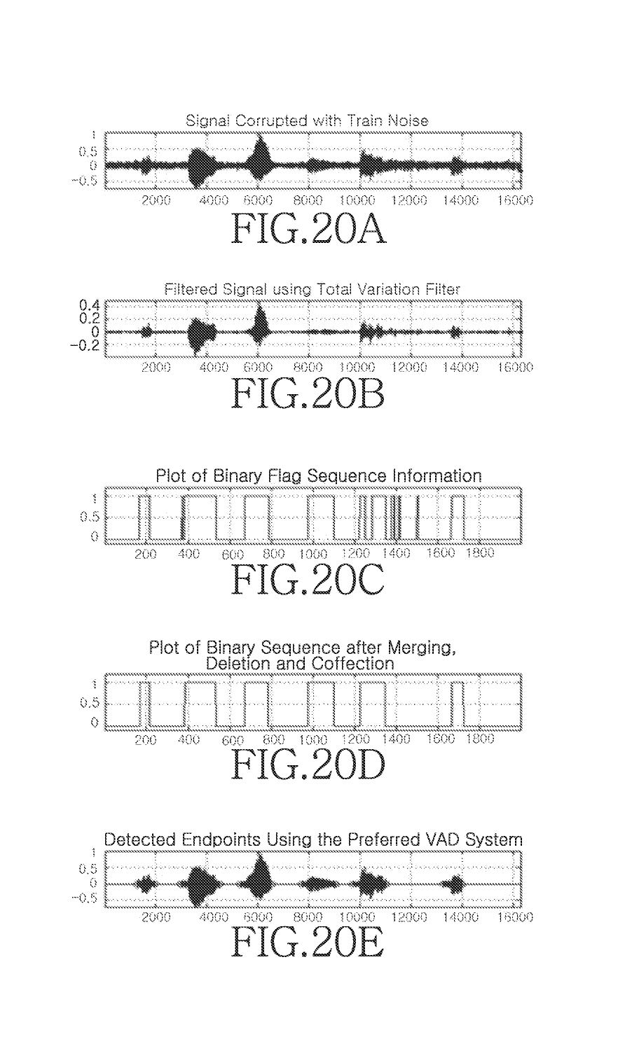

FIGS. 20A to 20E illustrate graphs indicating outputs of a VNFC module, a BSMD module and a VEDC module in accordance with various embodiments of the present disclosure.

FIG. 20A is a first plot depicting a clean signal. FIG. 20B is a second plot depicting a filtered signal using a total variation filter. FIG. 20C is a third plot depicting binary flag sequence information. FIG. 20C shows the output of a VNFC module. FIG. 20D is a fourth plot depicting binary sequences after merging, deletion and correction. FIG. 20D shows the output of a BSMD module. FIG. 20E is a fifth plot depicting detected endpoints using a VAD system. FIG. 20E demonstrates the output of a VEDC module. The endpoints of a voice signal portions are marked as circles.

FIGS. 18A to 18E, 19A to 19E, and 20A to 20E are graphical plots illustrating the outputs of a VNFC module, a BSMD module and a VEDC module, in accordance with embodiments of the present invention for speech signal corrupted by train noise, clean speech, and airport noise. The third plot is the output of a VNFC module. The fourth plot is the output of a BSMD module. The fifth plot demonstrates the output of a VEDC module. The endpoints of voice signal portions are marked as circles. Further, in some simulations, overall performance of the voice activity detection apparatus is evaluated using different speech signals corrupted by different types of noises such as airport, babble, car, train, exhibition, station, applause, laughter, AC noise, computer hardware, fan and white noise at varying noise levels. Experimental studies prove that the techniques and configurations of the proposed method for determining endpoints of voice signal portions in an audio signal overcome shortcomings of existing techniques. The third plot is the output of a VNFC module. The fourth plot is the output of a BSMD module. The fifth plot demonstrates the output of a VEDC module. The endpoints of a voice signal portions are marked as circles.

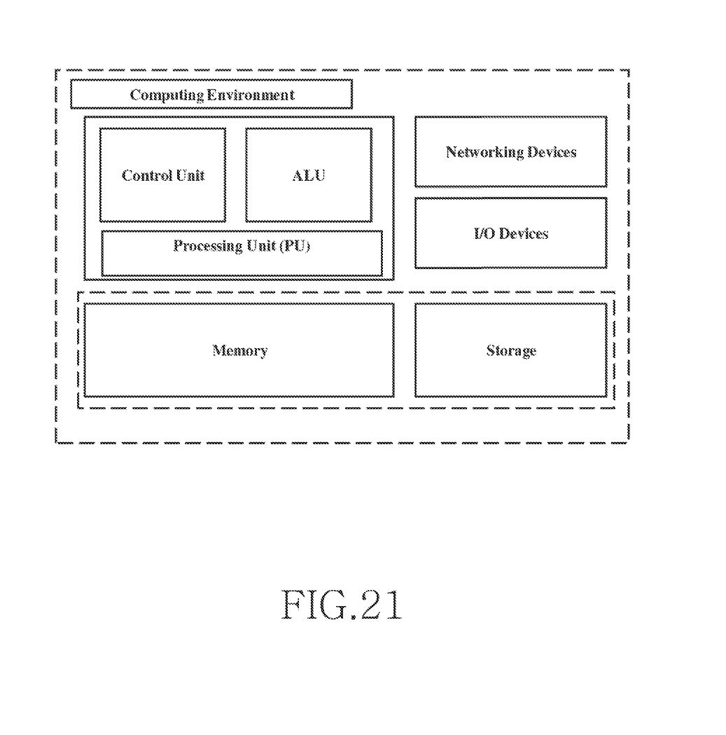

FIG. 21 illustrates a computing environment implementing the application in accordance with various embodiments of the present disclosure.

Referring to FIG. 21, the computing environment includes at least one processing unit that is equipped with a control unit and an Arithmetic Logic Unit (ALU), a memory, a storage unit, a plurality of networking devices, and a plurality of Input Output (I/O) devices. The processing unit is responsible for processing the instructions of the algorithm. The processing unit receives commands from the control unit in order to perform its processing. Further, any logical and arithmetic operations involved in the execution of the instructions are computed with the help of the ALU.

The overall computing environment can be composed of multiple homogeneous and/or heterogeneous cores, multiple CPUs of different kinds, special media and other accelerators. The processing unit is responsible for processing the instructions of the algorithm. The processing unit receives commands from the control unit in order to perform its processing. Further, any logical and arithmetic operations involved in the execution of the instructions are computed with the help of the ALU. Further, the plurality of process units may be located on a single chip or over multiple chips.

The algorithm comprising of instructions and codes required for the implementation are stored in either the memory unit or the storage or both. At the time of execution, the instructions may be fetched from the corresponding memory and/or storage, and executed by the processing unit.

In case of any hardware implementations various networking devices or external I/O devices may be connected to the computing environment to support the implementation through the networking unit and the I/O device unit.

The various embodiments disclosed herein can be implemented through at least one software program running on at least one hardware device and performing network management functions to control the elements. The elements shown in FIGS. 1 and 2 include blocks which can be at least one of a hardware device, or a combination of hardware device and software module.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for Voice Activity Detection (VAD) in an adverse environmental conditions, the method comprising:
receiving an input signal from at least one source;
classifying said input signal into at least one of a silent signal block and a non-silent signal block by comparing temporal feature information;
sending said at least one of said silent signal block or said non-silent signal block to at least one of a Voice Endpoint Storing (VES) module or a total variation filtering module by comparing said temporal feature information to a plurality of thresholds;
determining endpoint information of at least one of a voice signal or a non-voice signal;
employing total variation filtering for enhancing speech features and suppressing noise levels in non-speech portions;
determining a noise floor in said total variation filtered signal;
determining feature information in autocorrelation of said total variation filtered signal sequence;
determining Binary-flag Storing, Merging and Deletion (BSMD) based on said a duration threshold on said determined feature information by a BSMD module;
determining voice endpoint correction based on said temporal feature information after said determined BSMD; and
outputting said input signal with said voice endpoint information.

2. The method as in claim 1, wherein said temporal feature information comprises at least one of an energy, a zerocrossing rate, and an energy envelope that represents a various nature of an audio signal.

3. The method as in claim 1, wherein said method further comprises using lag of first zerocrossing point of autocorrelation sequence for detecting at least one of noise transients, and white Gaussian noise frames.

4. The method as in claim 1, further comprising determining feature information, wherein said feature information comprises at least one of decaying energy ratios, an amplitude, a lag of a minimum peak amplitude, a lag of a maximum peak, and a zerocrossing rate from said autocorrelation of said signal for discriminating said voice signals from said non-voice signal.

5. The method as in claim 4, further comprising determining said decaying energy ratios from said autocorrelation sequence to provide accurate characterizing of at least one of said voice signal and other background sounds.

6. The method as in claim 1, wherein said sending further comprises receiving a signal block from a signal block division module and computing temporal features for said signal block.

7. The method as in claim 1, further comprising estimating a noise floor from at least one of a total variation residual and said total variation filtered signal envelope which provides discrimination of said voice signal from said non-voice signal in said input signal.

8. The method as in claim 1, further comprising performing a sampling rate conversion depending on the voice processing applications on said received input signal.

9. The method as in claim 1, further comprising:
receiving a total variation filtered signal frame from a signal frame division module;
computing said temporal feature information for said signal frame;
comparing said feature information to thresholds;
sending said non-silent signal frame to a Voice/Non-voice Frame Classification (VNFC) module;
generating binary flag 0 information; and
sending said binary flag 0 information to said BMDS module.

10. The method as in claim 1, wherein said sending further comprises extracting feature information from said input signal by a Hierarchical Decision-Tree (HDT).

11. The method as in claim 10, wherein said HDT sends at least one of a silent signal or a non-silent signal to at least one of the VES module or the total variation filtering module by comparing said temporal features to threshold.

12. A system for Voice Activity Detection (VAD) in adverse environmental conditions, wherein said system is configured for:
receiving an input signal from at least one source;
classifying said input signal into at least one of a silent signal block or a non-silent signal block by comparing temporal feature information;
sending said at least one of said silent signal block or said non-silent signal block to at least one of a Voice Endpoint Storing (VES) module or a total variation filtering module by comparing said temporal feature information to the thresholds;
determining endpoint information of at least one of a voice signal or non-voice signal;
employing total variation filtering for enhancing speech features and suppressing noise levels in non-speech portions;
determining a noise floor in said total variation filtered signal;
determining feature information in autocorrelation of said total variation filtered signal sequence;
determining Binary-Flag Storing Merging and Deletion (BSMD) based on the a duration threshold on said determined feature information;
determining voice endpoint correction based on the temporal feature information after said determined BSMD; and
outputting said input signal with said voice endpoint information.

13. The system as in claim 12, wherein said system comprises a Voice/Non-voice Frame Classification (VNFC) module that is configured for:
receiving said non-silent signal frame from a Silent/Non-silent Frame Classification (SNFC) module;
computing a normalized single-sided Autocorrelation sequence of said non-silent signal frame;
computing feature parameters for a predefined lag range of said autocorrelation sequence;
comparing said features to said threshold;
generating binary flag 0 information which is sent to a BSMD module;
computing feature parameters for a predefined lag range of said autocorrelation sequence based on said comparison;
comparing said features to said thresholds;
generating at least one of binary-flag 1 or a binary flag-0; and
sending said generated binary flag sequence information to said BSMD module.

14. The system as in claim 12, wherein said parameters comprise at least one of a lag index of a first zerocrossing point, a zerocrossing rate, a lag index of a minimum point, an amplitude of a minimum point, a lag index of a maximum point, an amplitude of a maximum point, and decaying energy ratios.

15. The system as in claim 12, wherein said BSMD module is configured for:
receiving said binary flag sequence information;
finding locations of positive and negative transitions in said received binary flag sequence;
calculating a difference in said locations; and
comparing said difference with said threshold.

16. The system as in claim 12, wherein said BSMD module is configured to perform at least one of replacing a binary block of 0 with a binary block of 1, and replacing a binary block of 1 with a binary block of 0 after said comparing.

17. An apparatus for voice activity detection in adverse environmental conditions, wherein said apparatus comprises:
an integrated circuit further comprising at least one processor;
at least one memory having a computer program code within said integrated circuit;
said at least one memory and said computer program code configured to, with said at least one processor, cause said apparatus to:
receive an input signal from at least one source;
classify said input signal into at least one of a silent signal block or a non-silent signal block by comparing temporal feature information;
send said at least one of said silent signal block or said non-silent signal block to at least one of a Voice Endpoint Storing (VES) module or a total variation filtering module by comparing said temporal feature information to thresholds;
determine endpoint information of at least one of a voice signal or a non-voice signal by at least one of said VES module or said total variation filtering module;
employ total variation filtering by said total variation filtering module for enhancing speech features and suppressing noise levels in non-speech portions;
determine a noise floor in said total variation filtered signal domain;
determine feature information in autocorrelation of said total variation filtered signal sequence;
determine Binary-flag Storing, Merging and Deletion (BSMD) based on the duration threshold on said determined feature information by a BSMD module;
determine voice endpoint correction based on the short-term temporal feature information after said determined binary-flag merging and deletion; and
output said input signal with said voice endpoint information.

18. The apparatus as in claim 17, wherein said apparatus is configured to extract said temporal features from said input signal by a Signal Block Division (SBD) module.

19. The apparatus as in claim 17, wherein said apparatus is configured to send silent signal or non-silent signal extracting feature information from said input signal using a Hierarchical Decision-Tree (HDT) in a Silent/Non-silent Block Classification (SNBC) module.

20. The apparatus as in claim 17, wherein said apparatus is configured to send at least one of a silent signal or a non-silent signal to at least one of said VES module or said filtering module by comparing said temporal features to thresholds.

21. The apparatus as in claim 17, wherein said apparatus is configured to output said input signal with said voice endpoint information after correcting said endpoint information by a Voice Endpoint Determination and Correction (VEDC) module.

22. The apparatus as in claim 17, wherein said apparatus is configured for:
receiving audio data from at least one of a data acquisition module, audio communication, a storage device, and compressive sensing devices.

23. The apparatus as in claim 17, wherein said apparatus is configured for:
using said total variation filtering to enhance said voice features and suppress noise levels in said non-voice signal.

24. The apparatus as in claim 17, wherein said apparatus is configured for preventing pitch doubling and pitch halving errors.

25. The apparatus as in claim 17, wherein said apparatus is configured for triggering said VAD in at least one of a manual mode or an automatic mode selected by a user.
